(19) United States
(12) Patent Application Publication
(10) Pub. No.: US 2020/0396991 A1
(43) Pub. Date: Dec. 24, 2020

(54) PRODUCTION OF MEL-LIKE GLYCOLIPIDS AND LIPOPEPTIDES USING A BACILLUS SP. MICROORGANISM

(71) Applicant: LOCUS IP COMPANY, LLC, Solon, OH (US)

(72) Inventors: SEAN FARMER, NORTH MIAMI BEACH, FL (US); KEN ALIBEK, SOLON, OH (US); YAJIE CHEN, SOLON, OH (US)

(21) Appl. No.: 16/906,075

(22) Filed: Jun. 19, 2020

Related U.S. Application Data
(60) Provisional application No. 62/865,165, filed on Jun. 22, 2019.

(51) Int. Cl. A01N 25/30; A01N 43/16; A01N 63/10

(52) U.S. Cl. CPC A01N 25/30; A01N 63/10; A01N 43/16

(57) ABSTRACT

The subject invention provides improved methods for producing biosurfactants using bacteria not previously known to produce both glycolipids and lipopeptides. In particular, Bacillus amyloliquefaciens can be cultivated under specially-tailored conditions such that the bacteria produces both glycolipids resembling mannosylerythritol lipids (MEL), and lipopeptides. A bacterial culture composition is also provided, comprising bacterial cells, liquid growth medium and a high concentration of one or more growth by-products, such as MEL-like glycolipids and/or lipopeptides.

### CROSS-REFERENCE TO RELATED APPLICATION

This application claims priority to U.S. Provisional Patent Application No. 62/865,165, filed Jun. 22, 2019, which is incorporated herein by reference in its entirety.

### BACKGROUND OF THE INVENTION

Microorganisms, such as yeasts, fungi and bacteria, are important for the production of a wide variety of bio-preparations that are useful in many settings, such as oil and gas recovery; agriculture; remediation of soils, water and other natural resources; mining; animal feed; waste treatment and disposal; food and beverage preparation and processing; and human health.

Interest in microbial surfactants, in particular, has been steadily increasing in recent years due to their diversity, environmentally friendly nature, performance under extreme conditions, and potential applications in environmental protection. Microbially-produced surfactants, i.e., biosurfactants, are amphiphiles consisting of two parts: a polar (hydrophilic) moiety and non-polar (hydrophobic) group. Biosurfactants can include, for example, glycolipids, lipopeptides, flavolipids, phospholipids, fatty acid esters, and high-molecular-weight polymers such as lipoproteins, lipopolysaccharide-protein complexes, and/or polysaccharide-protein-fatty acid complexes.

Due to their amphiphilic structure, biosurfactants reduce the surface and interfacial tensions between the molecules of liquids, solids, and gases. Additionally, biosurfactants accumulate at interfaces, leading to the formation of aggregated micellar structures in solution. The ability of biosurfactants to form pores and destabilize biological membranes permits their use as, e.g., antibacterial and antifungal agents. Furthermore, they can inhibit microbial adhesion to a variety of surfaces, prevent the formation of biofilms, and can have powerful emulsifying and demulsifying properties.

Biosurfactants are biodegradable, have low toxicity, and can be produced using low-cost renewable resources. Most biosurfactant-producing organisms produce biosurfactants in response to the presence of a hydrocarbon source in the growing media. Other media components, such as concentration of minerals and pH, can also affect biosurfactant production significantly.

Microbial biosurfactants are produced by a variety of microorganisms such as bacteria, fungi, and yeasts, including, for example, Starmerella spp. (e.g., S. bombicola), Pseudomonas spp. (e.g., P. aeruginosa, P. putida, P. florescens, P. fragi, P. syringae); Flavobacterium spp.; Bacillus spp. (e.g., B. subtilis, B. amyloliquefaciens, B. pumillus, B. cereus, B. licheniformis); Wickerhamomyces spp. (e.g., W. anomalus), Candida spp. (e.g., C. albicans, C. rugosa, C. tropicalis, C. lipolytica, C. torulopsis); Saccharomyces (e.g., S. cerevisiae); Pseudozyma spp. (e.g., P. aphidis); Rhodococcus spp. (e.g., R. erythropolis); Ustilago spp.; Arthrobacter spp.; Campylobacter spp.; Cornybacterium spp.; as well as others.

One important class of biosurfactants is mannosylerythritol lipids (MEL). MEL are surface-active glycolipids with properties including, for example, viscosity reduction, emulsification, and nematode control. MEL and MEL-like substances are produced mainly by Pseudozyma spp., but some are also produced by Ustilago spp. (Arutchelvi et al., 2008).

MEL can be produced in more than 90 different combinations that fall under 5 main categories: MEL A, MEL B, MEL D, Tri-acetylated MEL A, and Tri-acetylated MEL BIC. Current production techniques take 10 to 14 days for accumulation of MEL using P. aphidis. The product then needs to be extracted using potentially harmful solvents and concentrated using a labor-intensive process. Thus, the commercialization of microbe-based products, such as MEL, has been limited by the inability to produce these products on a large scale.

Two principle forms of microbe cultivation exist for growing microbes and producing their growth by-products: submerged (liquid fermentation) and surface cultivation (solid-state fermentation (SSF)). Both cultivation methods require a nutrient medium for the growth of the microorganisms, and are classified based on the type of substrate used during fermentation (either a liquid or a solid substrate). The nutrient medium for both types of fermentation typically includes a carbon source, a nitrogen source, salts and other appropriate additional nutrients and microelements.

Microbes and their growth by-products have the potential to play highly beneficial roles in industries such as, for example, the petroleum and agriculture industries; however, more efficient methods are needed for producing the large quantities of microbe-based products, such as MEL and MEL-like substances, that are required for such applications.

### BRIEF SUMMARY OF THE INVENTION

The subject invention provides materials and methods for the efficient production and use of beneficial microbes, as well as for the production and use of substances, such as biosurfactants, derived from cultivation of these microbes.

In particular, the subject invention provides materials and methods for producing both glycolipid and lipopeptide biosurfactants using a single microorganism. Advantageously, the subject invention increases efficiency and reduces costs associated with biosurfactant production, compared to traditional production methods.

In general, the subject methods involve cultivating a bacterial strain under specially-tailored conditions that influence one or more biological mechanisms, which, when activated in the bacteria, result in the unnatural production of glycolipid biosurfactants concurrently with production of lipopeptide biosurfactants. In certain embodiments, the one or more biological mechanisms are inactive or weakly active in the bacteria, absent these influencing conditions.

In specific embodiments, the methods utilize a Bacillus spp. bacterium, preferably, B. amyloliquefaciens. While B. amyloliquefaciens is a known producer of lipopeptides, it was previously not known to possess the biological mechanism(s) and/or capability for producing both glycolipids and lipopeptides; thus, the methods of the subject invention provide for the unexpected and advantageous result of non-natural, concurrent glycolipid and lipopeptide production.

In certain specific embodiments, the methods utilize a specific strain of B. amyloliquefaciens, strain NRRL B-67928, referred to herein as “B. amy.”

In one embodiment, the method comprises inoculating a fermentation reactor comprising a liquid nutrient medium with an inoculum of a bacterium to produce a bacterial culture; and cultivating the bacterial culture under conditions that are favorable for production of glycolipids and lipopeptides to occur. In certain embodiments, the bacterium is a Bacillus spp. bacterium, preferably, B. amyloliquefaciens, even more preferably, B. amy.

The bacterial culture can be cultivated for an amount of time that allows for production of a desired concentration of glycolipids and/or lipopeptides in the culture. In certain embodiments, cultivation time is only about 20 to 30 hours.

In one embodiment, the conditions favorable for inducing production of glycolipids and lipopeptides include specific ranges of temperature, dissolved oxygen (DO) levels and/or pH levels.

In one embodiment, a favorable temperature is about 20 to 30° C., or about 22 to 24° C. In one embodiment, a favorable DO level is about 20% to about 70% of 100% ambient air, or about 30% to 60%. In one embodiment, a favorable pH is about 4.0 to about 8.0, or about 6.0 to about 7.5.

In certain embodiments, the liquid nutrient medium can also be specially-tailored to promote and/or induce production of glycolipids and lipopeptides. The nutrient medium can comprise a specific combination of sources of, for example, proteins, amino acids, antioxidants, fatty acids, vitamins, minerals, nitrogen, potassium, phosphorous, magnesium, calcium, sodium, carbon, salts, pH adjusters and/or other trace elements. In some embodiments, a de-foaming solution is added to the nutrient medium.

In some embodiments, nutrient medium, pH adjusters and/or de-foaming solution can be replenished during cultivation, for example, after about 14 to 16 hours of cultivation.

In certain embodiments, the methods of the subject invention utilize solid state fermentation (SSF), submerged fermentation, or modified and/or combined versions thereof. In preferred embodiments, the method utilizes submerged fermentation.

The methods can be scaled up or down. Most notably, the methods can be scaled to an industrial scale, i.e., a scale that is suitable for use in supplying biosurfactants in amounts to meet the demand for commercial applications, for example, production of compositions for enhanced oil recovery.

The subject methods can be useful for producing microbial growth by-products, such as biosurfactants. In particular, the subject invention can be used for the concurrent production of glycolipids and lipopeptides.

In specific embodiments, the glycolipids are MEL and/or “MEL-like” glycolipids. The general structure of a glycolipid comprises a mono- or oligosaccharide group attached to a sphingolipid or a glycerol group that can be acetylated or alkylated, and one or more fatty acids.

MEL are glycolipid biosurfactants comprising either 4-O-B-D-mannopyranosyl-meso-erythritol or 1-O-B-D-mannopyranosyl-meso-erythritol as the hydrophilic moiety, and fatty acid groups and/or acetyl groups as the hydrophobic moiety. One or two of the hydroxyls, typically at the C4 and/or C6 of the mannose residue, can be acetylated. Furthermore, there can be one to three esterified fatty acids, from 8 to 12 carbons or more in chain length.

MEL-like glycolipids according to the subject invention include amphiphilic molecules that comprise the general glycolipid structure and/or that structurally and/or functionally exhibit similarities to known MEL molecules. MEL-like glycolipids can include, for example, mannose-based amphiphilic molecules, fatty acid esters, and/or any isomer or analog of a molecule within these categories.

In a specific preferred embodiment, the MEL-like glycolipids produced according to the subject methods are oleic acid esters. Advantageously, in certain embodiments, the subject methods lead to production of surprisingly higher yields of MEL-like glycolipids than are achieved when MEL are produced using known methods (e.g., through cultivation of Pseudozyma and/or Ustilago), and in less time.

In some embodiments, the lipopeptides include, for example, surfactin, iturin, lichenysin, fengycin, plipastatins, kurstakins, arthrofactin, viscosin, or any other molecule characterized as a lipopeptide, and/or having analogous structure and/or function to these. In general, lipopeptides comprise a lipid connected to a peptide.

The microbial growth by-products produced according to the subject invention can be retained in the cells of the microorganisms and/or secreted into the liquid medium in which the microbes are growing.

In certain embodiments of the subject methods, after the fermentation cycle is ended, the bacterial culture is left to settle for about 8 to 15 hours at a temperature of 3 to 10° C., 5 to 7° C., or preferably 6° C. The settling period allows for cell biomass and biosurfactants to stratify into layers, where the cell biomass layer forms at the bottom of the culture and a viscous layer of glycolipids settles on top of the cells. In certain embodiments, the viscous layer comprises one or more glycolipids at a concentration of about 10% to about 14%. The entire viscous layer can be recovered from the culture simply by mechanical collection, and, if desired, can be purified according to known methods.

The bacterial culture, including the biomass and residual fermentation medium, can also be processed for further extraction in order to recover, for example, lipopeptides and/or other microbial growth by-products produced during cultivation. Processing can comprise, for example, centrifugation and washing, or other known methods, and can include optional purification.

In certain embodiments, the subject invention provides microbe-based products, as well as their uses in, for example, agriculture and/or enhanced oil recovery.

The microbe-based products can comprise the entire culture produced according to the subject methods, including the microorganisms and/or their growth by-products, as well as residual growth medium and/or nutrients. The microorganisms can be live, viable or in an inactive form. They can be in the form of a biofilm, vegetative cells, spores, and/or a combination thereof. In certain embodiments, no microbes are present, wherein the composition comprises microbial growth by-products, e.g., MEL-like glycolipids and/or lipopeptides, which have been extracted from the culture and, optionally, purified.

### BRIEF DESCRIPTION OF THE FIGURES

FIG. 1 shows the surface tension measurements of purified glycolipids produced by B. amyloliquefaciens according to embodiments of the subject invention at various dilution factors. The dilution was made with purified biosurfactants and DI water.

### DETAILED DESCRIPTION

The subject invention provides materials and methods for producing both glycolipids and lipopeptides using a single microorganism. Advantageously, the subject invention increases efficiency and reduces costs associated with biosurfactant production, compared to traditional production methods.

In general, the subject methods involve cultivating a bacterial strain under specially-tailored conditions that influence one or more biological mechanisms, which, when activated in the bacteria, result in the unnatural concurrent production of glycolipid biosurfactants with production of lipopeptide biosurfactants. In certain embodiments, the one or more biological mechanisms are inactive or weakly active in the bacteria, absent these influencing conditions. In specific embodiments, the methods utilize a Bacillus spp. bacterium, preferably, B. amyloliquefaciens, even more preferably, B. amy (strain NRRL B-67928).

### Selected Definitions

As used herein, a “biofilm” is a complex aggregate of microorganisms, wherein the cells adhere to each other and produce extracellular substances that encase the cells. Biofilms can also adhere to surfaces. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, genes or sequences, and/or amino acids or sequences, that flank it in its naturally-occurring state. An isolated microbial strain means that the strain is removed from the environment in which it exists in nature and/or in which it was cultivated. Thus, the isolated strain may exist as, for example, a biologically pure culture, or as spores, or other forms of propagule.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

As used herein, an “isomer” refers to a molecule with an identical chemical formula to another molecule, but having unique structures. Isomers can be constitutional isomers, where atoms and functional groups are bonded at different locations, and stereoisomers (spatial isomers), where the bond structure is the same but the geometrical positioning of atoms and functional groups in space is different. MEL isomers, for example, can differ in bond type and bond location of the carbohydrate, fatty acid and/or acetyl groups.

In contrast, an “analog” of a molecule does not have an identical chemical formula, but can have similar structure and/or functions. A “structural analog” or “chemical analog” is a compound having a structure that is similar to that of another compound, but having one or more differing components, such as one or more different atoms, functional groups, or substructures. As used herein, “functional analogs,” are compounds that have similar physical, chemical, biochemical, or pharmacological properties. Despite their similarities, however, chemical analogs can be, but are not always, functional analogs, and functional analogs can be, but are not always, chemical analogs.

A “metabolite” refers to any substance produced by metabolism (e.g., a growth by-product) or a substance necessary for taking part in a particular metabolic process. A metabolite can be an organic compound that is a starting material, an intermediate in, or an end product of metabolism. Examples of a metabolite include, but are not limited to, biosurfactants, enzymes, biopolymers, bioemulsifiers, acids, solvents, amino acids, nucleic acids, peptides, proteins, lipids, carbohydrates, vitamins and/or minerals.

The systems and methods of the subject invention can be used to produce microbe-based compositions. As used herein, a “microbe-based composition” is a composition that comprises components that were produced as the result of the growth of microorganisms or other cell cultures. Thus, the microbe-based composition may comprise the microbes themselves and/or by-products of microbial growth. The microbes may be in a vegetative state, in spore form, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. In some embodiments, the microbes are removed from the microbe-based composition. In some embodiments the microbes are present, with medium in which they were grown, in the microbe-based composition. The cells may be present at, for example, a concentration of at least 1×10⁴, 1×10⁵, 1×10⁶, 1×10⁷, 1×10⁸, 1×10⁹, 1×10¹⁰, 1×10¹¹, 1×10¹² or 1×10¹³ or more cells per gram or milliliter of the composition.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise only a portion of the product of cultivation (e.g., only the growth by-products), and/or the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers, such as amino acids, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein “reduction” means a negative alteration, and “increase” means a positive alteration, wherein the negative or positive alteration is at least 1%, 5%, 10%, 25%, 50%, 75%, or 100%.

As used herein, “surfactant” means a surface-active compound that lower the surface tension (or interfacial tension) between two liquids, between a liquid and a gas, or between a liquid and a solid. Surfactants act as, e.g., detergents, wetting agents, emulsifiers, foaming agents, and dispersants. A “biosurfactant” is a surface-active substance produced by a living cell.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19, or 20 as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially” of the recited component(s).

Unless specifically stated or obvious from context, as used herein, the term “or” is understood to be inclusive. Unless specifically stated or obvious from context, as used herein, the terms “a,” “an,” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

Any compositions or methods provided herein can be combined with one or more of any of the other compositions and methods provided herein.

Other features and advantages of the invention will be apparent from the following description of the preferred embodiments thereof, and from the claims. All references cited herein are hereby incorporated by reference.

### Methods for Producing Glycolipids and Lipopeptides

The subject invention provides methods for cultivation of microorganisms and production of microbial metabolites and/or other by-products of microbial growth using solid state fermentation, submerged fermentation, or a combination thereof. In preferred embodiments, cultivation is carried out using submerged fermentation.

As used herein “fermentation” refers to growth of cells under controlled conditions. The growth could be aerobic or anaerobic.

In one embodiment, the subject invention provides materials and methods for the production of biomass (e.g., viable cellular material), extracellular metabolites, residual nutrients, and/or intracellular components.

The methods can be scaled up or down in size. Most notably, the methods can be scaled to an industrial scale, i.e., a scale that is suitable for use in supplying biosurfactants in amounts to meet the demand for commercial applications, for example, production of compositions for enhanced oil recovery.

In specific embodiments, the subject invention provides materials and methods for producing glycolipids and lipopeptides concurrently, using one type of microorganism. Advantageously, the subject invention increases efficiency and reduces costs associated with glycolipid production, compared to traditional production methods.

The general structure of a glycolipid comprises a mono- or oligosaccharide group attached to a sphingolipid or a glycerol group that can be acetylated or alkylated, and one or more fatty acids. More specifically, in some embodiments, the glycolipids are MEL and/or “MEL-like” glycolipids.

MEL are glycolipid biosurfactants comprising either 4-O-B-D-mannopyranosyl-meso-erythritol or 1-O-B-D-mannopyranosyl-meso-erythritol as the hydrophilic moiety, and fatty acid groups and/or acetyl groups as the hydrophobic moiety. One or two of the hydroxyls, typically at the C4 and/or C6 of the mannose residue, can be acetylated. Furthermore, there can be one to three esterified fatty acids, from 8 to 12 carbons or more in chain length.

MEL-like glycolipids according to the subject invention include amphiphilic molecules that comprise the general glycolipid structure and/or that structurally and/or functionally exhibit similarities to known MEL molecules, such as MEL structural and/or functional analogs. MEL-like glycolipids can include, for example, mannose-based amphiphilic molecules and/or fatty acid esters.

In certain embodiments, the MEL and/or MEL-like glycolipids can have varying carbon-length chains or varying numbers of acetyl and/or fatty acid groups. The MEL and/or MEL-like glycolipids can include, for example, tri-acylated, di-acylated, mono-acylated, tri-acetylated, di-acetylated, mono-acetylated and non-acetylated varieties, as well as stereoisomers and/or constitutional isomers thereof.

Other MEL-like molecules, such as mannose-based amphiphilic molecules, can also be produced according to the subject invention, e.g., mannosyl-mannitol lipids (MML), mannosyl-arabitol lipids (MAL), and/or mannosyl-ribitol lipids (MRL).

In a specific preferred embodiment, the MEL-like glycolipids produced according to the subject methods are characterized as fatty acid esters. The fatty acid chain(s) of the fatty acid esters can comprise 6 to 22 carbons, 8 to 20 carbons, 10 to 18 carbons, or 12 to 16 carbons.

The fatty acid esters can include, for example, sugar fatty acid esters, fatty acid methyl esters (FAME), fatty acid ethyl esters, triglycerides, phospholipids, cholesterol esters and others. In certain preferred embodiments, the fatty acid ester(s) comprise oleic acid, e.g., methyl oleate (oleic acid methyl ester) or ethyl oleate (oleic acid ethyl ester).

Advantageously, in certain embodiments, the subject methods lead to production of surprisingly higher yields of MEL and/or MEL-like glycolipids than are achieved when MEL are produced using known methods (e.g., through cultivation of Pseudozyma and/or Ustilago), and in less time.

In certain embodiments, the lipopeptides produced according to the subject methods include, for example, surfactin, iturin, lichenysin, fengycin, plipastatins, kurstakins, arthrofactin, viscosin, or any other molecule characterized as a lipopeptide, and/or having analogous structure and/or function to these.

Lipopeptides, in particular, are oligopeptides synthesized by bacteria using large multi-enzyme complexes. They are frequently used as antibiotic compounds, and exhibit a wide antimicrobial spectrum of action, in addition to surfactant activities. The basic structure of a lipopeptide comprises a lipid connected to a peptide, with all lipopeptides sharing a common cyclic structure consisting of β-amino or β-hydroxy fatty acid integrated into a peptide moiety.

The subject methods involve cultivating a bacterial strain under specially-tailored conditions that influence one or more biological mechanisms, which, when activated in the bacteria, result in the unnatural production of glycolipid biosurfactants concurrently with production of lipopeptide biosurfactants. In certain embodiments, the one or more biological mechanisms are inactive or weakly active in the bacteria, absent these influencing conditions.

The microorganisms produced according to the subject invention can be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In specific embodiments, the methods utilize a Bacillus spp. bacterium. More specifically, in preferred embodiments, the bacterium is Bacillus amyloliquefaciens. Even more preferably, the bacterium is B. amyloliquefaciens NRRL B-67928, or “B. amy.”

A culture of the B. amyloliquefaciens “B. amy” microbe has been deposited with the Agricultural Research Service Northern Regional Research Laboratory (NRRL), 1400 Independence Ave., S.W., Washington, D.C., 20250, USA. The deposit has been assigned accession number NRRL B-67928 by the depository and was deposited on Feb. 26, 2020.

The subject culture has been deposited under conditions that assure that access to the culture will be available during the pendency of this patent application to one determined by the Commissioner of Patents and Trademarks to be entitled thereto under 37 CFR 1.14 and 35 U.S.C 122. The deposit is available as required by foreign patent laws in countries wherein counterparts of the subject application, or its progeny, are filed. However, it should be understood that the availability of a deposit does not constitute a license to practice the subject invention in derogation of patent rights granted by governmental action.

Further, the subject culture deposit will be stored and made available to the public in accord with the provisions of the Budapest Treaty for the Deposit of Microorganisms, i.e., it will be stored with all the care necessary to keep it viable and uncontaminated for a period of at least five years after the most recent request for the furnishing of a sample of the deposit, and in any case, for a period of at least 30 (thirty) years after the date of deposit or for the enforceable life of any patent which may issue disclosing the culture. The depositor acknowledges the duty to replace the deposit should the depository be unable to furnish a sample when requested, due to the condition of the deposit. All restrictions on the availability to the public of the subject culture deposit will be irrevocably removed upon the granting of a patent disclosing it.

While B. amyloliquefaciens is a known lipopeptide producer, it was previously not known to possess the biological mechanism(s) and/or capability for producing glycolipids in addition to lipopeptides; thus, the methods of the subject invention provide for the unexpected and advantageous result of non-natural, concurrent glycolipid and lipopeptide production by a strain of B. amyloliquefaciens, e.g., B. amy. Furthermore, the subject methods lead to surprisingly higher glycolipid yields than are achieved when producing MEL using standard cultivation of Pseudozyma and/or Ustilago, and in less time.

In certain embodiments, the total concentration of glycolipids produced according to the subject methods is at least 0.01%, 1%, 5%, 10%, 20%, 30%, 40%, 50%, 60%, 70%, 80%, 90%, 100%, or more, greater than when Pseudozyma spp. and/or Ustilago spp. are cultivated.

In one embodiment, the method comprises inoculating a fermentation reactor comprising a liquid nutrient medium with a Bacillus amyloliquefaciens bacterium to produce a bacterial culture; and cultivating the bacterial culture under conditions favorable for production of glycolipids and/or lipopeptides.

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, agitator shaft power, humidity, viscosity and/or microbial density and/or metabolite concentration.

In a further embodiment, the vessel may also be able to monitor the growth of microorganisms inside the vessel (e.g., measurement of cell number and growth phases). Alternatively, samples may be taken from the vessel and subjected to enumeration and/or purity measurement techniques known in the art, such as dilution plating technique. For example, in one embodiment, sampling can occur at 0 hr., and then one or more times daily, and/or at the time of harvesting microbes and/or microbial growth by-products from the reactor.

The microbial inoculant according to the subject methods preferably comprises cells and/or propagules of the desired microorganism, which can be prepared using any known fermentation method. In some embodiments, the propagules are spores. The inoculant can be pre-mixed with water and/or a liquid nutrient medium, if desired.

In one embodiment, seeding the system with the microbial inoculant can be performed by pumping, pouring, sprinkling or spraying the inoculum into the vessel being used for fermentation.

Activation, or germination, of spore-form microbes can be enhanced, at the time of inoculation, during cultivation or at the time of application, by adding L-alanine in low (micromolar) concentrations, manganese or any other known germinator, growth enhancer or stimulant.

In certain embodiments, the cultivation method utilizes submerged fermentation in a liquid nutrient medium. In one embodiment, the liquid nutrient medium comprises a carbon source. The carbon source can be a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, rice bran oil, olive oil, corn oil, sesame oil, and/or linseed oil; powdered molasses, etc. These carbon sources may be used independently or in a combination of two or more.

In one embodiment, the liquid nutrient medium comprises a nitrogen source. The nitrogen source can be, for example, potassium nitrate, ammonium nitrate, ammonium sulfate, ammonium phosphate, ammonia, urea, and/or ammonium chloride. These nitrogen sources may be used independently or in a combination of two or more.

In one embodiment, one or more inorganic salts may also be included in the liquid nutrient medium. Inorganic salts can include, for example, potassium dihydrogen phosphate, monopotassium phosphate, dipotassium hydrogen phosphate, disodium hydrogen phosphate, potassium chloride, magnesium sulfate, magnesium chloride, iron sulfate, iron chloride, manganese sulfate, manganese chloride, zinc sulfate, lead chloride, copper sulfate, calcium chloride, calcium carbonate, calcium nitrate, magnesium sulfate, sodium phosphate, sodium chloride, and/or sodium carbonate. These inorganic salts may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, proteins and microelements can be included, for example, corn flour, peptone, yeast extract, potato extract, beef extract, soybean extract, banana peel extract, and the like, or in purified forms. Amino acids such as, for example, those useful for biosynthesis of proteins, can also be included.

The method of cultivation can further provide oxygenation to the growing culture. One embodiment utilizes slow motion of air to remove low-oxygen containing air and introduce oxygenated air. The oxygenated air may be ambient air supplemented daily through mechanisms including impellers for mechanical agitation of the liquid, and air spargers for supplying bubbles of gas to the liquid for dissolution of oxygen into the liquid. In certain embodiments, dissolved oxygen (DO) levels are maintained at about 25% to about 75%, about 30% to about 70%, about 35% to about 65%, about 40% to about 60%, or about 50% of air saturation. Air flow can be supplied at, for example, about 0.5 to about 2.0 v/m, or about 1.0 to about 1.5 vvm.

In preferred embodiments, a de-foaming solution is included in the nutrient medium to reduce the production of foam and promote the separation of glycolipids from the culture when the culture is left to settle. The de-foamer can be any know solution for reducing foam formation during cultivation, including, for example oil-based de-foamers, water-based de-foamers, silicone-based de-foamers, polyethylene glycol/polypropylene glycol-based de-foamers, and/or alkyl polyacrylates. In one embodiment, the de-foamer is an oil-based de-foamer, e.g., DG-959 (Organic Defoamer Group) or canola oil. The de-foamer concentration is preferably about 1% to about 10%, or about 2% to about 6% by volume. In some embodiments, the fermentation reactor is fed with additional de-foamer solution after about 14 to about 16 hours of fermentation.

In some embodiments, the method for cultivation may further comprise adding acids and/or antimicrobials in the liquid medium before and/or during the cultivation process to protect the culture against contamination. In some embodiments, however, the metabolites produced by the bacterial culture provide sufficient antimicrobial effects to prevent contamination of the culture.

In one embodiment, prior to inoculation, the components of the liquid culture medium can optionally be sterilized. If used, the anchoring carrier is also preferably sterilized, for example, using an autoclave or other method known in the art. Additionally, water used for preparing the medium can be filtered to prevent contamination.

In one embodiment, sterilization of the liquid nutrient medium can be achieved by placing the components of the liquid culture medium in water at a temperature of about 85-100° C. In one embodiment, sterilization can be achieved by dissolving the components in 1 to 3% hydrogen peroxide in a ratio of 1:3 (w/v).

In one embodiment, the equipment used for cultivation is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of pH and/or low water activity may be exploited to control unwanted microbial growth.

The pH of the mixture should be suitable for the microorganism of interest. In some embodiments, the pH is about 2.0 to about 11.0, about 3.0 to about 10.0, about 4.0 to about 9.0, about 5.0 to about 8.0, or about 6.0 to about 7.5. In one embodiment, the pH is about 6.6 to about 7.2. Buffers, and pH regulators, such as carbonates and phosphates, may be used to stabilize pH near a preferred value. In certain embodiments, a base solution is used to adjust the pH of the bacterial culture to a favorable level, for example, a 15% to 30%, or a 20% to 25% NaOH. The base solution can be included in the nutrient medium and/or it can be fed into the fermentation reactor during cultivation to adjust the pH, for example, after about 14 to 16 hours.

In one embodiment, the method of cultivation is carried out at about 5° to about 100° C., about 15° to about 60° C., about 20° to about 45° C., or about 24° to about 30° C. In one embodiment, the cultivation may be carried out continuously at a constant temperature. In another embodiment, the cultivation may be subject to changing temperatures.

According to the subject methods, the microorganisms can be incubated in the fermentation system for a time period sufficient to achieve a desired effect, e.g., production of a desired amount of cell biomass or a desired amount of one or more microbial growth by-products. The biomass content may be, for example from 5 g/l to 180 g/l or more, or from 10 g/l to 150 g/l.

In certain embodiments, fermentation of the bacterial culture occurs for 12 to 36 hours, or for 20 to 28 hours, or about 24 hours. The microbial growth by-product produced by the bacterium may be retained in the microorganisms or secreted into the growth medium. In some embodiments, despite the use of an anti-foaming solution, some amount of a foam layer is produced during cultivation. The foam layer can comprise some microbial growth by-products, such as lipopeptides.

At the end of the fermentation cycle, in some embodiments, the bacterial culture is left to settle for about 8 to 15 hours at a temperature of 3 to 10° C., 5 to 7° C., or preferably about 6° C. The bacterial culture can be kept in the fermentation reactor, or it can be transferred to a separate container for settling.

As the bacterial culture settles, a layer of cell biomass settles to the bottom of the reactor, and a viscous glycolipid layer forms and settles on top of the cell biomass layer. In certain embodiments, the glycolipid layer will not form unless a de-foaming solution is added to the nutrient medium.

In some embodiments, the viscous layer comprises a glycolipid concentration of about 10% to about 14%. The glycolipid layer can be harvested and, optionally, concentrated and/or purified.

The glycolipid layer that is collected from the settled bacterial culture can be processed by, e.g., washing and/or centrifuging, to extract the microbial growth by-products. Optionally, the growth by-products can then be stored, purified, and/or used directly in crude form. In one embodiment, the growth medium may contain compounds that stabilize the activity of the microbial growth by-product.

The bacterial culture, including the biomass and residual fermentation medium, as well as any foam produced, can also be processed for further extraction in order to recover, for example, lipopeptides and/or other microbial growth by-products produced during cultivation. Processing can comprise, for example, centrifugation and washing, or other known methods, and can include optional purification.

The subject methods can be used to produce high concentrations of glycolipids, for example, about 0.5 g/L to about 100 g/L, about 1 g/L to about 75 g/L, about 2 g/L to about 50 g/L, about 3 g/L to about 25 g/L, about 4 g/L to about 20 g/L, or about 5 g/L to about 15 g/L of MEL and/or MEL-like glycolipids.

The subject methods can also be used to produce high concentrations of lipopeptides, for example, about 0.5 g/L to about 100 g/L, about 1 g/L to about 75 g/L, about 2 g/L to about 50 g/L, about 3 g/L to about 25 g/L, about 4 g/L to about 20 g/L, or about 5 g/L to about 15 g/L of one or more lipopeptides.

The methods can be performed in a batch, quasi-continuous, or continuous processes. In one embodiment the entire bacterial culture is removed upon the completion of cultivation (e.g., upon, for example, achieving a desired cell density or metabolite concentration). In this batch procedure, an entirely new batch is initiated upon harvesting of the first batch.

In another embodiment, only a portion of the culture is removed at any one time. In this manner, a continuous or quasi-continuous system is created. The composition that is removed can be a cell-free liquid, and/or it can contain some cells.

### Preparation of Microbe-Based Products

In certain embodiments, the subject invention provides microbe-based products, as well as their uses in a variety of settings including, for example, oil and gas recovery; bioremediation and mining; waste disposal and treatment; animal health (e.g., livestock production and aquaculture); plant health and productivity (e.g., agriculture, horticulture, crops, pest control, forestry, turf management, and pastures); and human health (e.g., probiotics, pharmaceuticals and cosmetics).

One microbe-based product of the subject invention is simply a bacterial culture comprising bacterial cells, a nutrient medium, and one or more biosurfactants. The one or more biosurfactants can be retained in the cells of the bacteria and/or present as a secretion in the nutrient medium, e.g., in the form of a viscous layer or a foam layer. The bacterial culture can also comprise other metabolites produced by the bacteria.

The microbe-based products may be used without further stabilization, preservation, and storage. Advantageously, direct usage of the microbe-based products preserves a high viability of the microorganisms, reduces the possibility of contamination from foreign agents and undesirable microorganisms, and maintains the activity of the by-products of microbial growth.

If present in the microbe-based product, the microorganisms may be in an active or inactive form. In some embodiments, the microorganisms have sporulated or are in spore form. The amount of biomass in the composition, by weight, may be, for example, from 0% to 100%, 10% to 90%, 20% to 80%, 30% to 70%, or 40% to 60%, inclusive of all percentages therebetween.

In one embodiment, the composition does not comprise living microorganisms. In one embodiment, the composition does not comprise microorganisms at all, whether living or inactive.

The product of fermentation may be used directly without extraction or purification. If desired, however, extraction and purification can be easily achieved. In some embodiments, all or a portion of the entire culture, including the biosurfactants, can be harvested from the vessel and then processed to recover the biosurfactants. For example, in some embodiments, the culture is centrifuged to remove the bacterial cells and then subjected to known extraction and, optionally, purification methods to recover the biosurfactants. All or a portion of the product can also be dried and later dissolved in water.

In some embodiments, extraction does not require solvents. In some embodiments, standard extraction methods or techniques known to those skilled in the art, including those that use solvents, can be employed.

Advantageously, in accordance with the subject invention, the microbe-based product may comprise the substrate in which the microbes were grown. In one embodiment, the composition may be, for example, at least 1%, 5%, 10%, 25%, 50%, 75%, or 100%, by weight, growth medium.

In one embodiment, the compositions comprise one or more microbial growth by-products, wherein the growth by-product has been extracted from the culture and, optionally, purified. For example, in one embodiment, the composition comprises a viscous glycolipid layer that forms during cultivation, and settles to the bottom of the culture. This layer can be extracted and then subjected to known purification methods.

In a specific preferred embodiment, the composition comprises glycolipid molecules and/or lipopeptide molecules, such as those described above. For example, the bacterial culture can comprise about 0.5 g/L to about 100 g/L, about 1 g/L to about 75 g/L, about 2 g/L to about 50 g/L, about 3 g/L to about 25 g/L, about 4 g/L to about 20 g/L, or about 5 g/L to about 15 g/L of MEL and/or MEL-like glycolipids;

and/or about 0.5 g/L to about 100 g/L, about 1 g/L to about 75 g/L, about 2 g/L to about 50 g/L, about 3 g/L to about 25 g/L, about 4 g/L to about 20 g/L, or about 5 g/L to about 15 g/L of one or more lipopeptides.

In certain embodiments, the use of crude/unpurified forms of microbial growth by-products according to the subject invention can have advantages over, for example, purified microbial metabolites alone, due to, for example, the use of the entire culture. Additionally, the compositions can comprise a variety of microbial metabolites (e.g., biosurfactants, enzymes, acids, solvents, and other) in the culture that may work in synergy with one another to achieve a desired effect.

In some embodiments, the composition can be placed in containers of appropriate size, taking into consideration, for example, the intended use, the contemplated method of application, the size of the fermentation vessel, and any mode of transportation from a microbe growth facility to the location of use. Thus, the containers into which the microbe-based composition is placed may be, for example, from 1 gallon to 1,000 gallons or more. In certain embodiments the containers are 2 gallons, 5 gallons, 25 gallons, or larger.

The microbe-based product can be removed from the container and transferred to the site of application via, for example, tanker, for immediate use.

Upon harvesting the microbe-based composition from the growth vessels, further components can be added as the harvested product is placed into containers and/or piped (or otherwise transported for use). The additives can be, for example, buffers, carriers, other microbe-based compositions produced at the same or different facility, viscosity modifiers, preservatives, nutrients for microbe growth, tracking agents, pesticides, and other ingredients specific for an intended use.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

### Methods of Use

The compositions of the subject invention can be used for a variety of purposes. In one embodiment, the composition can be used in agriculture. For example, methods are provided wherein a composition produced according to the subject invention is applied to a plant and/or its environment to treat and/or prevent the spread of pests and/or diseases. The composition can also be useful for enhancing water dispersal and absorption in the soil, as well as enhance nutrient absorption from the soil through plant roots, facilitate plant health, increase yields, and manage soil aeration.

In one embodiment, the subject compositions can be highly advantageous in the context of the oil and gas industry. When applied to an oil well, wellbore, subterranean formation, or to equipment used for recovery oil and/or gas, the compositions produced according to the subject invention can be used in methods for enhancement of crude oil recovery; reduction of oil viscosity; removal and dispersal of paraffin from rods, tubing, liners, and pumps; prevention of equipment corrosion; recovery of oil from oil sands and stripper wells; enhancement of fracking operations as fracturing fluids; reduction of H₂S concentration in formations and crude oil; and cleaning of tanks, flowlines and pipelines.

In one embodiment, the compositions produced according to the subject invention can be used to improve one or more properties of oil. For example, methods are provided wherein the composition is applied to oil or to an oil-bearing formation in order to reduce the viscosity of the oil, convert the oil from sour to sweet oil, and/or to upgrade the oil from heavy crude into lighter fractions.

In one embodiment, the compositions produced according to the subject invention can be used to clean industrial equipment. For example, methods are provided wherein a composition is applied to oil production equipment such as an oil well rod, tubing and/or casing, to remove heavy hydrocarbons, paraffins, asphaltenes, scales and other contaminants from the equipment. The composition can also be applied to equipment used in other industries, for example, food processing and preparation, agriculture, paper milling, and others where fats, oils and greases build up and contaminate and/or foul the equipment.

In one embodiment, the compositions produced according to the subject invention can be used to enhance animal health. For example, methods are provided wherein the composition can be applied to animal feed or water, or mixed with the feed or water, and used to prevent the spread of disease in livestock and aquaculture operations, reduce the need for antibiotic use in large quantities, as well as to provide supplemental proteins and other nutrients.

In one embodiment, the compositions produced according to the subject invention can be used to prevent spoilage of food, prolong the consumable life of food, and/or to prevent food-borne illnesses. For example, methods are provided wherein the composition is applied to a food product, such as fresh produce, baked goods, meats, and post-harvest grains, to prevent undesirable microbial growth.

Other uses for the subject compositions include, but are not limited to, biofertilizers, biopesticides, bioleaching, bioremediation of soil and water, pharmaceutical adjuvants (for increasing bioavailability of orally ingested drugs), cosmetic products, control of unwanted microbial growth, and many others.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used. For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This makes the system efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

In one embodiment, the microbe growth facility is located on, or near, a site where the microbe-based products will be used, for example, within 300 miles, 200 miles, or even within 100 miles. Advantageously, this allows for the compositions to be tailored for use at a specified location. The formula and potency of microbe-based compositions can be customized for a specific application and in accordance with the local conditions at the time of application.

Advantageously, distributed microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

Furthermore, by producing a composition locally, the formulation and potency can be adjusted in real time to a specific location and the conditions present at the time of application. This provides advantages over compositions that are pre-made in a central location and have, for example, set ratios and formulations that may not be optimal for a given location.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products.

Local production and delivery within, for example, 24 hours of fen fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention.

### Example 1—Production of Glycolipids and Lipopeptides

A Bacillus amyloliquefaciens inoculum is grown in a small-scale reactor for 24 to 48 hours. A fermentation reactor is inoculated with the inoculum to produce a bacterial culture. The nutrient medium comprises:

| | |
|---|---|
| Molasses | 10 to 20 g/L |
| Corn peptone | 1 to 5 g/L |
| K₂HPO₄ | 0.1 to 0.5 g/L |
| KH₂PO₄ | 0.1 to 0.5 g/L |
| MgSO₄•7H₂O | 0.1 to 0.5 g/L |
| NaCl | 0.1 to 0.5 g/L |
| CaCO₃ | 0.5 to 1.5 g/L |
| Ca(NO₃)₂•4H₂O | 0.1 to 1.0 g/L |
| Yeast extract | 0.5 to 1.5 g/L |
| MnCl₂•4H_{2O} | 0.001 to 0.05 g/L |
| Trace elements | 0.5 to 1.5 g/L |
| Oil-based defoamer | 5 to 30 g/L |

An aqueous base solution comprising 20% NaOH is fed into the reactor to adjust and maintain pH automatically to/at about 6.6 to about 7.2.

Temperature is maintained at about 24° C.; DO is maintained at about 50%; and air flow rate is maintained at about 1 vvm.

Additional base solution is fed into the reactor as needed to automatically adjust pH. A 6% de-foamer solution is fed into the reactor at about 14 to 16 hours of cultivation to control foam production.

Total fermentation time is about 24 hours. After the cycle ends, the bacterial culture is placed into a tank and allowed to settle at about 6° C. for about 8 to 12 hours. A viscous glycolipid layer settles to the bottom of the culture and is harvested for optional purification using ethyl acetate extraction and a rotary evaporator.

Sampling of the fermenter for CFU count, sporulation percentage and/or purity is performed at 0 hr, then twice per day throughout fermentation. The samples, as well as unpurified products, are stored at about 4° C.

The growth by-products, either in purified or unpurified form, can be analyzed to confirm, for example, the presence of biosurfactants.

The glycolipid layer produced by B. amyloliquefaciens was analyzed using LC-MS, and the results exhibited a molecular weight match with the known molecular weight of MEL molecules. Thin layer chromatography analysis showed a sugar moiety and fatty acid chain(s), confirming the presence of glycolipids.

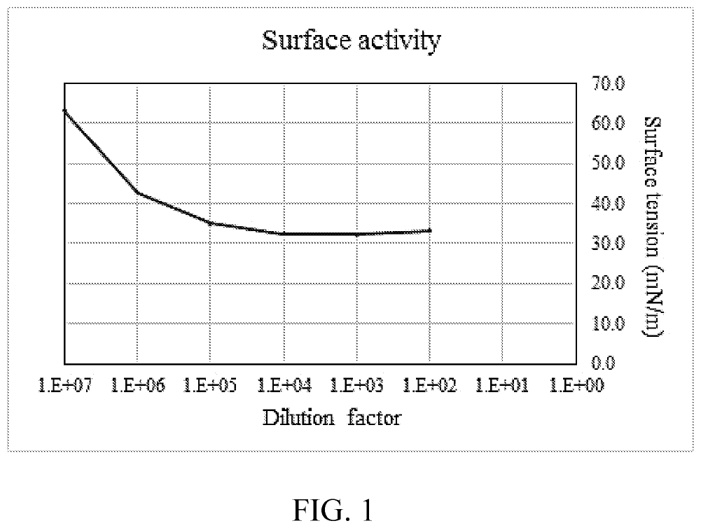

The growth by-products were also tested for surface tension reduction capabilities, indicating the presence of biosurfactants. When added to water, the surface tension was reduced from <60 mN/m to about 32 nM/m. FIG. 1.

We claim:

1. A method for producing one or more biosurfactants, the method comprising:
a) inoculating a fermentation reactor comprising a liquid nutrient medium with a Bacillus spp. bacterium to produce a bacterial culture comprising bacteria cells and nutrient medium;
b) cultivating the bacterial culture for 12 to 36 hours at a temperature, pH, and dissolved oxygen favorable for inducing production of biosurfactants;
c) after cultivation, allowing the bacterial culture to settle at a temperature of 3 to 10° C., wherein bacterial cell biomass settles to the bottom of the bacterial culture, and a viscous layer forms its on top of the settled cell biomass, said viscous layer comprising one or more glycolipid biosurfactants; and
d) extracting the viscous layer from the bacterial culture.

2. The method of claim 1, wherein the nutrient medium comprises molasses, corn peptone, monopotassium phosphate, dipotassium phosphate, magnesium sulfate, sodium chloride, calcium chloride, calcium nitrate, yeast extract, manganese chloride, and trace elements.

3. The method of claim 2, wherein the nutrient medium further comprises a de-foamer.

4. The method of claim 3, wherein the de-foamer is a 0.5 to 2% oil-based de-foamer.

5. The method of claim 1, wherein a pH adjuster is added to the nutrient medium to adjust the pH of the bacterial culture to about 6.0 to 7.5.

6. The method of claim 1, wherein a 6% oil-based de-foamer is fed into the reactor after about 14 to 16 hours of cultivation.

7. The method of claim 1, wherein the temperature is about 20 to 30° C.

8. The method of claim 1, wherein the DO is about 40% to 60% of air saturation.

9. The method of claim 1, wherein cultivation occurs for about 20 to 30 hours.

10. The method of claim 1, further comprising concentrating and/or purifying the glycolipid biosurfactants from the extracted viscous layer.

11. The method of claim 1, wherein the glycolipid biosurfactants comprise mannosylerythritol lipids (MEL) and/or MEL-like glycolipids.

12. The method of claim 11, wherein the MEL-like glycolipids are fatty acid ester compounds.

13. The method of claim 12, wherein the fatty acid ester compounds are oleic acid esters selected from ethyl oleate and methyl oleate.

14. The method of claim 11, wherein the MEL molecule is a MEL A (di-acetylated), MEL B (mono-acetylated at C4), MEL C (mono-acetylated at C6), MEL D (non-acetylated), tri-acetylated MEL A, and/or tri-acetylated MEL B/C.

15. The method of claim 1, wherein the Bacillus spp. bacterium further produces lipopeptide biosurfactants into the nutrient medium.

16. The method of claim 15, wherein the lipopeptide biosurfactants are surfactins, iturins, fengycins, plipastatins, kurstakins, and/or lichenysins.

17. The method of claim 15, further comprising extracting the lipopeptide biosurfactants from the bacterial culture and optionally, concentrating and/or purifying the lipopeptide biosurfactants.

18. The method of claim 1, wherein the Bacillus spp. bacterium is a strain of B. amyloliquefaciens.

19. The method of claim 18, wherein the strain is NRRL B-67938, “B. amy.”

20. A bacterial culture comprising cells of Bacillus amyloliquefaciens, a liquid nutrient medium, and at least 0.5 g/L of one or more biosurfactants, said biosurfactants comprising MEL, MEL-like glycolipids and/or lipopeptides.

21. The bacterial culture of claim 20, comprising 0.5 g/L to 100 g/L of the one or more biosurfactants.
